(19) United States
(12) Patent Application Publication
(10) Pub. No.: US 2022/0032697 A1
(43) Pub. Date: Feb. 3, 2022

(54) Method for Fabricating a Tow Hook Assembly

(71) Applicant: Trenton Forging Company, Trenton, MI (US)

(72) Inventors: David Moxlow, Grosse Ile, MI (US); Dane Moxlow, Grosse Ile, MI (US); Robert Hopkins, Woodhaven, MI (US)

(73) Assignee: Trenton Forging Company, Trenton, MI (US)

(21) Appl. No.: 16/943,059

(22) Filed: Jul. 30, 2020

(51) Int. Cl. B60D 1/04; C21D 9/46; C21D 9/00

(52) U.S. Cl. CPC B60D 1/04; C21D 9/0068; C21D 9/46

(57) ABSTRACT

A method for manufacturing a tow hook assembly begins with heating a first steel blank to within a range of 2200° F. and 2300° F. to create a first heated steel blank. A second steel blank is heated to within the range of 2200° F. at 2300° F. to create a second heated steel blank. The first heated steel blank is forged into a tow hook. The second heated steel blank is forged into a flange plate. The tow hook in the flange plate are welded together to form the tow hook assembly. This method reduces waste by minimizing the size of the first and second steel blanks.

### BACKGROUND ART

### 1. Field of the Invention

The invention relates generally to a method for manufacturing a forged part. More particularly, the invention relates to a method of manufacturing a high strength complex tow hook.

### 2. Description of the Related Art

Tow hook assemblies are devices that are secured to vehicles allowing the vehicles to be towed and to tow. These assemblies need to be compact, designed to be as aesthetically pleasing as possible, and they need to be functional. To be functional, the tow hook assemblies must be strong enough to handle the forces generated in a towing event. As such, the tow hook assemblies must be strong.

### SUMMARY OF THE INVENTION

A method for manufacturing a tow hook assembly begins with heating a first steel blank to within a range of 2200° F. and 2300° F. to create a first heated steel blank. A second steel blank is heated to within the range of 2200° F. at 2300° F. to create a second heated steel blank. The first heated steel blank is forged into a tow hook. The second heated steel blank is forged into a flange plate. The tow hook in the flange plate are welded together to form the tow hook assembly.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of one embodiment of a fabricated tow hook assembly;

FIG. 2 is a perspective view of a tow hook;

FIG. 3 is a perspective view of a flange plate; and

FIG. 4 is a logic diagram of one embodiment of the method to fabricate a tow hook assembly.

### DETAILED DESCRIPTION OF THE PREFERRED EMBODIMENT

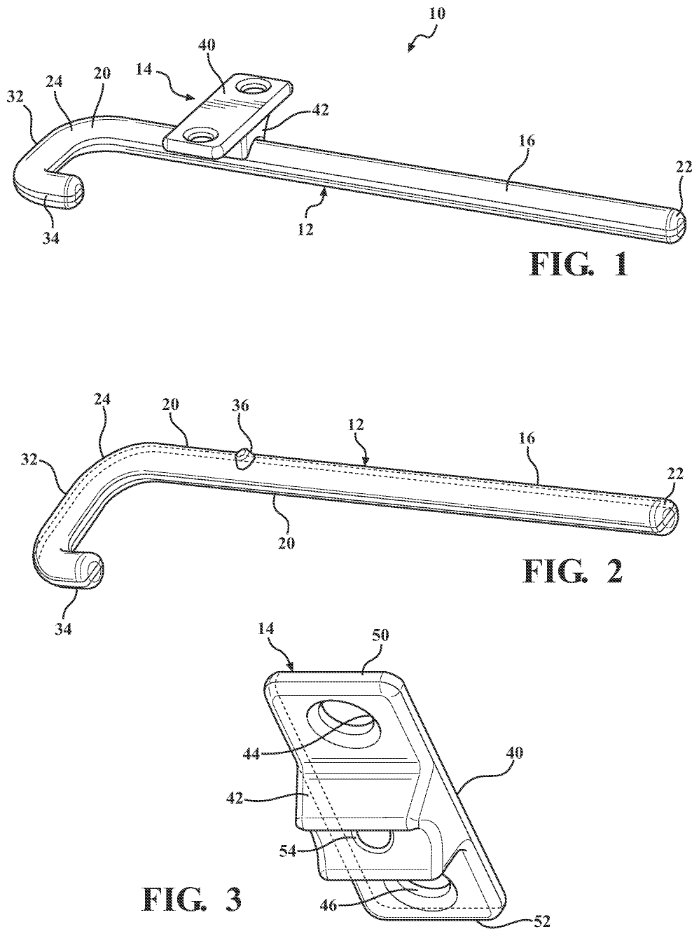

Referring to FIG. 1, a tow hook assembly is generally indicated at 10. The tow hook assembly 10 includes a main body, generally shown at 12, and a flange plate, generally shown at 14. The main body 12 includes a cylindrical extension 16 that extends from an operational end 20 and a distal end 22. The cylindrical extension 16 has a circular cross section. It should be appreciated by those skilled in the art that the cylindrical extension 16 may have a non-circular cross section. The distal end 22 may be threaded or it may have another securing device to secure the main body 12 to a vehicle (not shown).

Formed out of the operational end 20 is a hook 24. The hook 24 has a support end 26 that extends out from the operational end 20 in a generally co-planar manner. The hook 24 includes a transverse section 32. The transverse section 32 receives the forces generated from the towing activity. The transverse section 32 receives another hook, a rope, or towing straps (none shown) when the tow hook assembly 10 is being utilized. A retention end 34 extends out from the transverse section 32 in a direction back toward the main body 12 and is used to retain whatever is being coupled to the tow hook assembly 10 for operation from sliding off the transverse section 32.

Referring to FIG. 2, the main body 12 and hook 24 are shown without the flange plate 14 secured thereto. An alignment boss 36 extends up from the main body 12 near the operational end 20 thereof. The alignment boss 36 will be discussed in greater detail subsequently.

The flange plate 14 includes a top plate 40 and a connecting body 42 extending down from the top plate 40. The top plate includes two holes 44, 46 disposed adjacent to ends 50, 52, respectively. The two holes 44, 46 receive bolts (not shown) therein, whereby nuts threadingly engage the bolts and tighten the flange plate 14 to a support structure of the vehicle. The connecting body 42 extends down and engages the main body 12. The connecting body 42 includes an alignment recess 54 that receives the alignment boss 36 therein. This ensures that the flange plate 14 and the main body 12 are in alignment when fabricated.

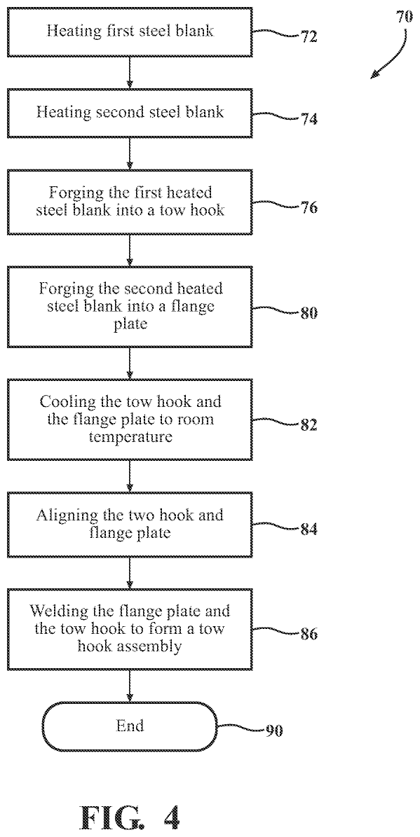

Referring to FIG. 4, a method used to fabricate a tow hook assembly 10 is generally indicated at 70. The method begins at 72 by heating a first steel blank. A second steel blank is heated at 74. Both the first and second steel blanks are heated to a temperature within a range of 2200° F. and 2300° F. Heating the first steel blank 72 and the second steel blank 74 may be done together or the steps 72, 74 may be done independently, discussed subsequently. When heated, the first steel blank and second steel blank are in a plastic state optimized for forging, as determined by the type of steel being used.

When heated, the first heated steel blank is then forged into the main body 12 (a tow hook) at 76. The second heated steel blank is forged into the flange plate 14 at 80. Steps 76 and 80 may be performed in parallel or in series and that is because the parts being fabricated are cooled after they are forged, so they can be made at the same time or at different times. In their formation, the alignment recess 54 is formed in the flange plate 14 and an alignment boss 36 is formed to extend out from the main body 12.

As stated above, the main body 12 and the flange plate 14 are cooled at 82 after they are formed. As stated above, the main body 12 in the flange plate 14 may be forged at the same time or they may be forged sequentially. This is because once the main body 12 in the flange plate 14 are forged, they are cooled to room temperature. Room temperature is defined as the temperature by which operators of the forging equipment can function.

The tow hook main body 12 and the flange plate 14 are aligned at 84. The flange plate 14 is placed over the main body 12 allowing the alignment boss 36 to be inserted into the alignment recess 54. Once aligned, the flange plate 14 is welded to the main body 12 to create the tow hook assembly 10 at 86. By forging the flange plate 14 independent of the tow hook main body 12, the tow hook assembly 10 is made in a process that reduces the amount of waste material being created when the tow hook assembly 10 is forged as a unitary product. The reduction of waste material is augmented by the use of round or cylindrical billet for the first steel blank. As it should be appreciated by those skilled in the art, the use of two steel blanks further reduces waste as opposed to forging the tow hook assembly 10 from a single billet. The method ends at 90.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A method for manufacturing a tow hook assembly, the method comprising the steps of:
heating a first steel blank to within a range between 2200° F. and 2300° F. to create a first heated steel blank;
heating a second steel blank to within a range between 2200° F. and 2300° F. to create a second heated steel blank;
forging the first heated steel blank into a tow hook main body;
forging the second heated steel blank into a flange plate; and
welding the tow hook in the flange plate together to form a tow hook assembly.

2. A method as set forth in claim 1 including the step of cooling the tow hook main body and the flange plate prior to the step of welding.

3. A method as set forth in claim 2 wherein the step of cooling reduces the temperature of the tow hook main body and the flange plate to room temperature.

4. A method as set forth in claim 1 wherein the step of forging the flange plate includes forming two holes.

5. A method as set forth in claim 3 including the step of forming an alignment boss in the tow hook main body.

6. A method as set forth in claim 5 including the step of forming an alignment recess in the flange plate.

7. A method as set forth in claim 6 including the step of inserting the alignment boss of the tow hook into the alignment recess of the flange prior to the step of welding and after the step of cooling.
